(19) United States
(12) Patent Application Publication
(10) Pub. No.: US 2003/0052779 A1
(43) Pub. Date: Mar. 20, 2003

(54) Anti-hijacking cockpit door system for aircraft

(76) Inventors: Daniel H. Martin, Las Vegas, NV (US); Todd E. Davis, Las Vegas, NV (US)

Correspondence Address: DANIEL MARTIN, Suite 14, 3155 E Patrick Lane, Las Vegas, NV, 89120, US

(21) Appl. No.: 09/955,813

(22) Filed: Sep. 18, 2001

(51) Int. Cl. G08B 21/00

(52) U.S. Cl. 340/541; 340/686.1; 340/945; 340/550; 244/119; 244/129.4

(57) ABSTRACT

An aircraft cockpit door system is disclosed comprising a bulletproof cockpit door and bulkhead, and a bulletproof lavatory isolation door and bulkhead. A logic control circuit alternately locks the two doors, keeping the cockpit crew at all times isolated from other persons aboard the craft to ensure the safety of the cockpit crew, and ultimately the aircraft.

### BACKGROUND OF THE INVENTION

1. Field of the Invention

In common use in aircraft are cockpit doors to separate the cockpit from the passenger cabin of aircraft. Cockpit doors are commonly constructed of lightweight plastic and aluminum components, and are generally designed for privacy without regard for high security.

Aircraft lavatories are commonly located aft of the cockpit. Therefore, the cockpit crew must open the cockpit door prior to utilizing the lavatory. This exposes the cockpit crew to any potential threat present in the passenger cabin, even if the closed cockpit door has sufficient structural integrity to protect the cockpit from an attacker.

The present invention relates to isolating the cockpit crew from threats from the passenger cabin, notably that of hijackers.

2. Description of the Prior Art

U.S. Pat. No. 5,933,098 utilizes transmitters to transmit an alarm when an intrusion is detected or when an aircraft fails to check in when scheduled. Properly implemented, this could inform anyone who received the transmission of a hijacking in progress, but could not prevent a hijacking from occurring.

### BRIEF SUMMARY OF THE INVENTION

The present invention provides for a bulletproof cockpit door, and a bulletproof lavatory isolation door located aft of the forward lavatory. The cockpit crew may access the lavatory only when the lavatory isolation door is locked, thereby isolating the cockpit crew from the passenger cabin. The cockpit door and lavatory isolation door are preferably each attached to a bulletproof bulkhead.

Inspection means is provided to ensure that the lavatory isolation area is secure prior to entrance from the cockpit.

### DETAILED DESCRIPTION OF THE INVENTION

In the preferred embodiment, the cockpit door and lavatory isolation door are designed with a layer of Kevlar® or other bulletproof material to prevent bullet penetration while keeping the overall weight to a minimum. The bulletproof standard is utilized for ultimate protection of the cockpit crew, but implementation of the design described will also protect against access with a cutting instrument or use of force, such as kicking the door.

The doors each utilize at least one pneumatic or electric-solenoid lock preferably designed with a manual release on the cockpit side in case of emergency. Proximity switches, mechanical switches, or a combination thereof are utilized to confirm the locked or unlocked status of the door, and at least one wide-angle viewing lens is utilized to inspect the secure area before opening the cockpit door.

Also provided for are a series of optical, infrared, or ultrasonic sensors located between the cockpit door and lavatory isolation door, as well as in the forward lavatory, to alert the cockpit crew if someone is present.

In the preferred embodiment, a programmable logic controller (PLC) operates the lock so that the cockpit door lock will only unlock when the lavatory isolation door is locked, and the sensors indicate that no one is present in the secure area between the doors or in the forward lavatory. In this embodiment, the lavatory isolation door will only unlock when the cockpit door is secure and the sensors indicate that no one is present in the secure area between the doors or in the forward lavatory.

In the preferred embodiment, a layer of Kevlar® or other bulletproof material is utilized on the cockpit bulkhead, to protect the cockpit crew from small arms fire through the forward wall of the lavatory, which is commonly located directly behind the captain's seat. Similarly, a layer of Kevlar® or other bulletproof material is utilized on the lavatory isolation bulkhead.

In one embodiment, miniature video cameras are located strategically throughout the aircraft to allow the cockpit crew to view in real time, all passenger areas and cargo holds, enabling the cockpit crew to know what is happening on other parts of the aircraft in a time of crisis.

References herein to the details are by way of example only and not intended to limit the scope of the claims which themselves recite those details regarded as important to the invention.

1. An aircraft bulkhead door system constructed to withstand forceful contact from persons or projectiles comprising:
a) a partition dividing a forward portion of an aircraft cabin from an aft portion of an aircraft cabin, partially comprising a layer of Kevlar® or other bulletproof materials;
b) a door within said partition to allow passage when desired, partially comprising a layer of Kevlar® or other bulletproof materials; and
c) a locking mechanism to prevent undesired passage.

2. A dual bulkhead door system comprising:
a) a first bulkhead system comprising:
1) a first partition dividing a forward portion of an aircraft from an aft portion of an aircraft,
2) a first door within the first partition to allow passage when desired,
3) a first locking mechanism to prevent undesired passage, and
4) indication means to confirm the locked or unlocked state of the first door;
b) a second bulkhead system comprising:
1) a second partition dividing a forward portion of an aircraft from an aft portion of an aircraft,
2) a second door within the second partition to allow passage when desired, and
3) a second locking mechanism to prevent undesired passage;
4) indication means to confirm the locked or unlocked state of the second door;

3. The dual bulkhead door system of claim 2 further comprising sensing means to detect the presence of undesired objects or persons located in that portion of the aircraft between the first bulkhead system and the second bulkhead system.

4. The dual bulkhead door system of claim 3 wherein said sensing means comprises at least one proximity sensor.

5. The dual bulkhead door system of claim 3 wherein said sensing means comprises at least one infrared sensor.

6. The dual bulkhead door system of claim 3 wherein said sensing means comprises at least one ultrasonic sensor.

7. The dual bulkhead door system of claim 3 wherein said sensing means comprises at least one photocell sensor.

8. The dual bulkhead door system of claim 3 wherein said sensing means comprises at least one laser sensor.

9. The dual bulkhead door system of claim 3 wherein the locking mechanisms are controlled by a logic control circuit.

10. The dual bulkhead door system of claim 9 wherein the logic control circuit prevents the first door from opening if the second door is not locked.

11. The dual bulkhead door system of claim 9 wherein the logic control circuit prevents the second door from opening if the first door is not locked.

12. The dual bulkhead door system of claim 9 wherein the logic control circuit prevents the first door from opening if an undesired object or person is present in that portion of the aircraft located between the first bulkhead system and the second bulkhead system.

13. The dual bulkhead door system of claim 9 wherein the logic control circuit prevents the second door from opening if an undesired object or person is present in that portion of the aircraft located between the first bulkhead system and the second bulkhead system.

14. The dual bulkhead door system of claim 9 wherein the first bulkhead system separates the cockpit from the remainder of the aircraft and the first locking mechanism can be manually unlocked from the cockpit side only.

15. The dual bulkhead door system of claim 14 wherein the logic control circuit automatically locks the second door when:
a) the cockpit crew attempts to unlock the first door, and
b) no undesired object or person is present in that portion of the aircraft located between the first bulkhead system and the second bulkhead system.

16. The dual bulkhead door system of claim 14 wherein the first door is constructed with a wide-angle viewing device providing the cockpit crew with a view of that portion of the aircraft located between the first bulkhead system and the second bulkhead system.

17. The dual bulkhead door system of claim 2 further comprising means to equalize cabin pressure forward and aft of the dual bulkhead door system in case of rapid decompression of the aircraft.

18. An aircraft bulkhead system comprising:
a) a door frame attached to a lavatory bulkhead on one side, and attached to a bulkhead on the opposite side,
b) a door within said door frame to allow passage when desired, partially comprising a layer of Kevlar® or other bulletproof materials; and
c) a locking mechanism to prevent undesired passage.

19. The aircraft bulkhead system of claim 18 wherein said bulkhead comprises a galley bulkhead.

20. The aircraft bulkhead system of claim 18 wherein a layer of Kevlar® or other bulletproof materials is used within said lavatory bulkhead.

21. The aircraft bulkhead system of claim 19 wherein a layer of Kevlar® or other bulletproof materials is used within said galley bulkhead.
